(19) United States
(12) Patent Application Publication
(10) Pub. No.: US 2022/0129739 A1
(43) Pub. Date: Apr. 28, 2022

(54) METHOD AND SYSTEM FOR CONVOLUTION MODEL MULTI-MODE HARDWARE ACCELERATOR

(71) Applicant: VASTAI Holding Company, Grand Cayman (KY)

(72) Inventors: Lei Zhang, Richmond Hill (CA); Jun Qian, Shanghai (CN)

(21) Appl. No.: 17/310,420

(22) PCT Filed: Feb. 19, 2020
(86) PCT No.: PCT/CA2020/050211

§ 371 Date: Aug. 2, 2021

Related U.S. Application Data
(60) Provisional application No. 62/807,518, filed on Feb. 19, 2019.

(51) Int. Cl. G06N 3/063; G06N 3/04

(52) U.S. Cl. CPC G06N 3/063; G06N 3/04

(57) ABSTRACT

A method and system for a convolution model multi-mode hardware accelerator. The method comprises receiving a stream of an input feature map into the one or more processors utilizing a convolution model that includes a plurality of convolution layers, estimating a sparsity characteristic of a data portion that encompasses at least one of the plurality of convolution layers, the data portion comprising at least one of weights and input data, processing, in accordance with the sparsity characteristic, the data portion of the convolution model using a first and a second hardware accelerator modes, and in accordance with the processing, generating a plurality of output features that are interpretive of the input feature map.

### CROSS-REFERENCE TO RELATED APPLICATION(S)

This application is a continuation of International Application No. PCT/CA2020/050211 filed on Feb. 19, 2020, which claims priority to U.S. Application No. 62/807,518, filed on Feb. 19, 2019, the entire disclosures of which are hereby incorporated by reference.

### TECHNICAL FIELD

The disclosure herein relates to the field of processor techniques, devices and systems for machine learning models including convolution networks.

### BACKGROUND

Machine learning systems provide critical tools to advance new technologies including automatic speech recognition, autonomous vehicles, computer vision, and natural language understanding. Convolution models including convolution neural networks have been shown to be effective tools for performing image recognition, detection, and retrieval. Before a neural network can be used for these inference tasks, it must be trained using a data corpus in a computationally very intensive process, in which existing systems may typically require weeks to months of time on graphic processing units (GPUs) or central processing units.

As more and more data are included for training and machine learning inference networks, the computational processing time required is further exacerbated. Hardware accelerators are more energy efficient than existing GPU-based based approaches, and significantly reduce the energy consumption required for neural network training and inference tasks.

### BRIEF DESCRIPTION OF THE DRAWINGS

FIG. 1A illustrates, in an example embodiment, a convolution model instance for implementing a hardware accelerator in a convolution model having a single output filter support.

FIG. 1B illustrates, in another example embodiment, a convolution model instance for implementing a hardware accelerator in a convolution model having multiple output filters support.

FIG. 2 illustrates, in one example embodiment, an architecture of a platform device, including one or more processors, implementing a convolution model multi-mode hardware accelerator.

FIG. 3 illustrates an example embodiment of implementing a convolution model multi-mode hardware accelerator.

FIG. 4 illustrates a method of operation, in one example embodiment, for implementing a convolution model multi-mode hardware accelerator.

### DETAILED DESCRIPTION

Among other technical advantages and benefits, solutions herein provide for utilizing a combination of a first and at least a second hardware accelerator processing modes, for multi-mode contemporaneous processing. A decision of which mode to deploy for processing a given portion of the convolution model layers may be based on a sparsity estimate for output filters and input feature data associated with that respective portion of the convolution model layers. The term sparsity as used herein refers to the number of zero's (0's) of which the output filters (or weights) and input feature data of a given convolution model layer are constituted. Solutions herein deploy a first mode in conjunction with at least a second mode for processing convolution model layers constituted of data portions and depending on whether a sparsity estimate falls below or above a predetermined threshold level of sparsity. Solutions herein recognize that hardware accelerators used for machine learning inference and training workloads often provide higher throughput whilst consuming lower power than CPUs or GPUs. With regard to convolution models in particular, multi-instance machine learning hardware accelerators may be implemented to provide higher throughput compared to a single instance hardware accelerator, further enhancing speed and efficiency with regard to machine learning workloads.

Multi-instance hardware accelerators can be all used for one single machine learning job. For example, all the instances of the hardware accelerator can be used to do machine learning inference work of a single image at the same time, typically for batch one inference. A specific mode, the sparsity mode, utilizes the fact there can be a lot of zeros (0's) in the input feature data and the output filters (also referred to herein as weights) portion of the convolution model. The input data and weights with 0's components are not used in multiplication part of the computations in a given machine learning job, and this aspect may be applied to select optimal and complementary processing modes using the techniques and systems herein for deploying multi-mode hardware accelerators to further speed up machine learning tasks.

Another particular mode is the Winograd mode, which relies on transforming data from time domain to frequency domain and reduces the number of multiplications by a factor of 2.25 for 2D array. This also significantly speed up the machine learning jobs, up to a theoretical of 2.25×

Among other advantages and benefits, the disclosure herein provides a novel way to decide whether sparsity mode or Winograd mode is used for machine learning jobs in accordance with convolution models, to increase a level of multi-mode processing parallelism and reduce overall computational times.

In accordance with a first example embodiment, a method of implementing a convolution model multi-mode hardware accelerator is provided. The method comprises receiving a stream of an input feature map into the one or more processors utilizing a convolution model that includes a plurality of convolution layers, estimating a sparsity characteristic of a data portion that encompasses at least one of the plurality of convolution layers, the data portion comprising at least one of output filters and input feature data, processing, in accordance with the sparsity characteristic, the data portion of the convolution model using a first and a second hardware accelerator modes, and in accordance with the processing, generating a plurality of output features that are interpretive of the input feature map.

In accordance with a second example embodiment, a processing system that includes one or more processors and a memory storing instructions executable in the one or more processor to provide a convolution model multi-mode hardware accelerator is disclosed. The memory includes instructions executable to receive a stream of an input feature map into the one or more processors utilizing a convolution model that includes a plurality of convolution layers, estimate a sparsity characteristic of a data portion that encompasses at least one of the plurality of convolution layers, the data portion comprising at least one of weights and input data, process, in accordance with the sparsity characteristic, the data portion of the convolution model using a first and a second hardware accelerator modes, and in accordance with the processing, generate a plurality of output features that are interpretive of the input feature map.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device.

Furthermore, one or more embodiments described herein may be implemented through the use of logic instructions that are executable by one or more processors. These instructions may be carried on a computer-readable medium. In particular, machines shown with embodiments herein include processor(s), various forms of memory for storing data and instructions, including interface and associated circuitry. Examples of computer-readable mediums and computer storage mediums include flash memory and portable memory storage units. A processor device as described herein utilizes memory, and logic instructions stored on computer-readable medium. Embodiments described herein may be implemented in the form of computer processor- executable logic instructions in conjunction with programs stored on computer memory mediums, and in varying combinations of hardware in conjunction with the processor- executable instructions or code.

### SYSTEM DESCRIPTION

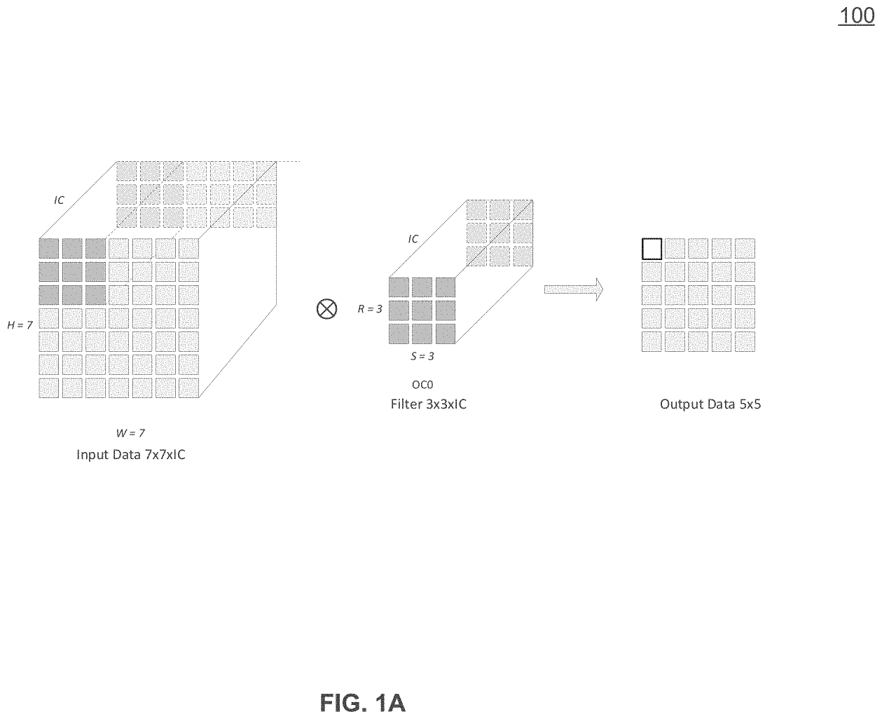

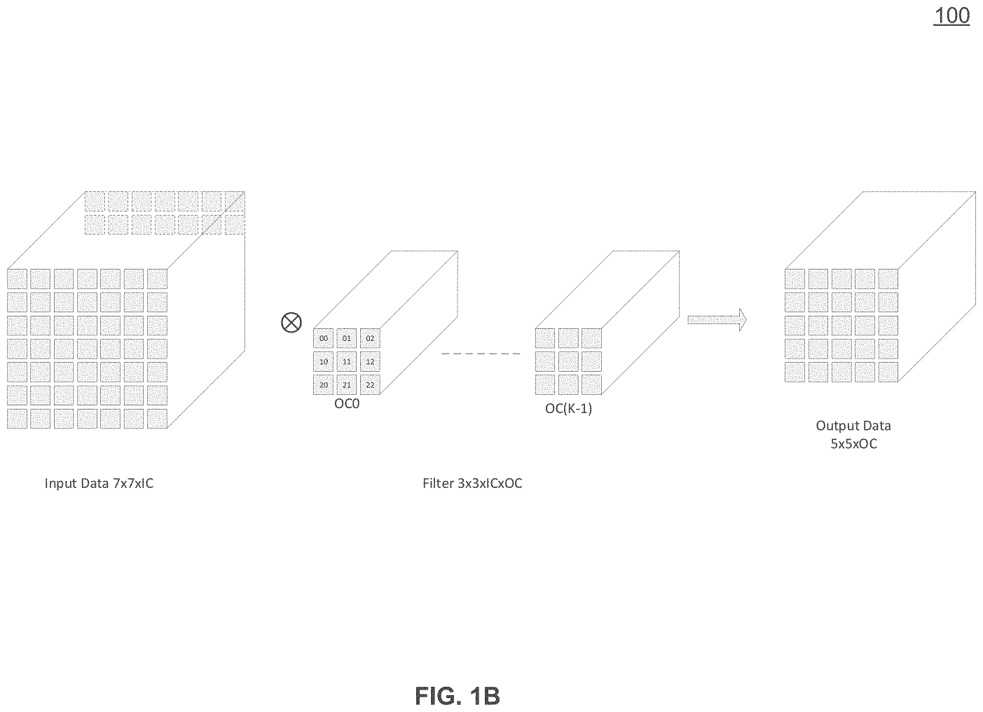

FIG. 1A illustrates, in an example embodiment, a convolution model instance for implementing a hardware accelerator, having a single output filter support. The convolution operation typically embodies two parts of inputs: one is input feature map data, and the other is a filter (variously referred to as output filter, or kernel, or weight). Given the input channel data with W(Width)×H(Height)×IC data cube and RxSxIC filter, the output of direct convolution may be formulated as:

$${y}_{w , h} = {\sum }_{r = 0}^{R - 1} {\sum }_{s = 0}^{S - 1} {\sum }_{c = 0}^{C - 1} {x}_{( w + r ) , ( h + s ) , c} * {w}_{r , s , c}$$

where:
X=input data/input feature/input feature map
w=width of the input or output data
h=height of the input or output data
R=kernel size (width)
S=kernel size (height)
C=number of input channel
Y=output data/output feature/output feature map
W=filter/kernel/weight

FIG. 1A illustrates an input of 7×7×IC, where IC is the number of input channels. The input of 7×7 is used in this example case and the input resolution size can vary. A filter can have different sizes, typical sizes are 1×1, 3×3, 5×5, 7×7, etc. A filter of 3×3 comprises 9 weights (or 9 values) in the example here. For each input channel, the 3×3 filter, or weight, are convoluted with 3×3 data and generates 1 output data. The same location of data of all the input channels are summed together and generate 1 output data channel. The final output of 5×5 output data is shown in FIG. 1A.

An output filter is applied to detect a particular feature of the input map from an input data stream, for example, to detect lines that curve outward and to the right. Other filters may detect other features of the input map, such as for lines that curve to the left or for straight edges. The more filters, the greater the depth of the activation map, and the more information we have about the input volume.

This leads to output channel (OC) definitions. Each OC is represented by an output filter used to detect one particular feature or pattern of the input feature map data stream. FIG. 1A shows 1 output filter (1 OC). Normally in deep learning networks there are many OCs (output filters) to look for different information, features or patterns in the data stream of an input feature map.

FIG. 1B illustrates, in another example embodiment, another convolution model instance for implementing a hardware accelerator; in particular, a convolution model having multiple output filters support. In the example of FIG. 1B, the input feature data is still 7×7×IC. For each output filter, after convolution, a 5×5 output data is generated, as in FIG. 1A. Total of 5×5×OC output data is generated for K-1 number of output channel filters.

Machine learning inference and training networks are typically are modeled to include many convolution layers. Typically, the output of one layer becomes the input of the next layer. For example, in FIG. 1B, if IC of the current layer is 128 and OC is 256, then the input of the current layer is 7×7×128 and the output is 7×7×256. The input of the next layer is 7×7×256.

While hardware accelerators are primarily described in the disclosure herein, it is contemplated that the techniques and system can be extended to central processing unit (CPU) and general purpose processing unit (GPU) implementation of the machine learning inference and training workloads.

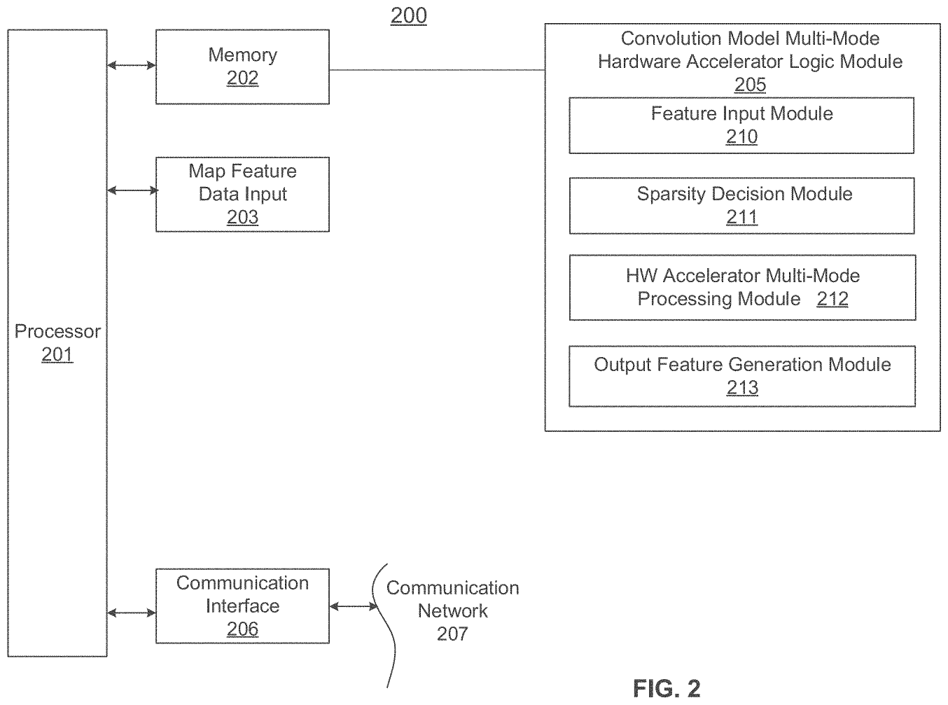

FIG. 2 illustrates, in one example embodiment, an architecture 200 of a platform device or processing system, including one or more processors, implementing a convolution model multi-mode hardware accelerator.

Convolution model multi-mode hardware accelerator logic module 205 may include instructions stored in memory 202 executable in conjunction with processor 201. In implementations, the functionality ascribed to processor 201 may be performed using multiple processors deployed in cooperation. Convolution model multi-mode hardware accelerator logic module 205 may comprise portions or sub-modules including feature input module 210, sparsity decision module 211, hardware accelerator multi-mode processing module 212 and output feature generation module 213. In alternative implementations, it is contemplated that at least some hard-wired circuitry may be used in place of, or in combination with, all or certain portions of the software logic instructions of convolution model multi-mode hardware accelerator 205 to implement hardware accelerator examples described herein. Thus, the examples described herein are not limited to particular fixed arrangements of hardware circuitry and software instructions.

Feature input module 210 of convolution model multi-mode hardware accelerator logic module 205 may include instructions executable in processor 201 to receive a stream of an input feature map into the one or more processors utilizing a convolution model that includes a plurality of convolution layers.

Sparsity decision module 211 of convolution model multi-mode hardware accelerator logic module 205 may include instructions executable in processor 201 to estimate a sparsity characteristic of a data portion that encompasses at least one of the plurality of convolution layers, the data portion comprising at least one of output filters and input feature data.

Hardware accelerator multi-mode processing module 212 of convolution model multi-mode hardware accelerator logic module 205 may include instructions executable in processor 201 to process, in accordance with the sparsity characteristic, the data portion of the convolution model using at least a first and a second hardware accelerator modes. In some embodiments, more than one hardware accelerators working in conjunction may be implemented in the processing system.

Output feature generation module 213 of convolution model multi-mode hardware accelerator logic module 205 may include instructions executable in processor 201 to, in accordance with the reconfigured computational order, generate at least output features that are interpretive of the input feature map.

### METHODOLOGY

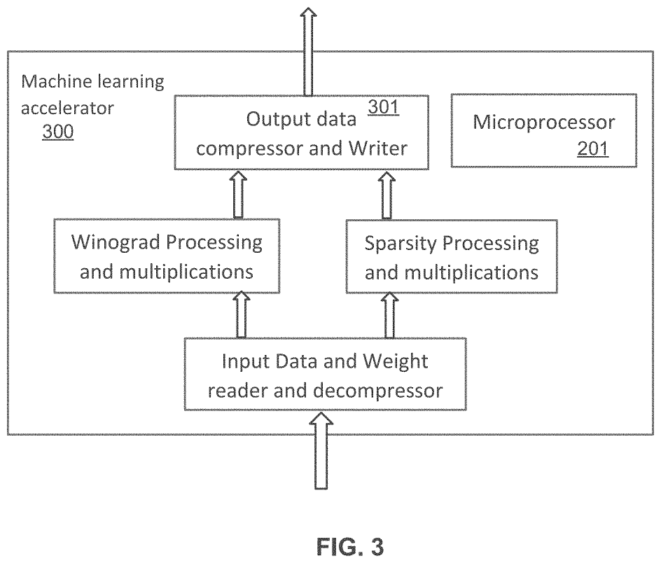

FIG. 3 illustrates an example embodiment of implementing a convolution model multi-mode hardware accelerator 300. Input data and weight reader may read input data and weight from memories outside of the machine learning accelerator. Input data and weight are sometimes compressed to save memory bandwidth and decompression may be required. Depending on the level of sparsity from input feature data and weight detected, processing may be parallel for data portions having greater or lesser than a predetermined threshold sparsity level. In the example depicted, for sparsity levels greater than the threshold, sparsity processing may be based on multiplications for data portions, while contemporaneously, processing of other data portions having sparsity levels less than the threshold may be in accordance with a Winograd algorithm and multiplications.

Microprocessor 201 decides for the given network layer, it should operate in the sparsity mode or Winograd mode. In the sparsity mode, sparsity processing and multiplications are performed. In the Winograd mode, Winograd processing and multiplications are performed. Hardware resources such as multipliers may be shared between Winograd mode and sparsity mode processing in the example embodiment illustrated. Resultant output data may be sent to an output data compressor and writer block. Output data is sometimes compressed before being written out to memories external to the machine learning accelerator 300 to save memory bandwidth and/or power. Microprocessor 201 is used here as an example, and it is contemplated other hardware or software can be used instead.

The decision on whether nor not to use the sparsity mode for processing may, in one example embodiment, be based on the number of zeros in the input data. When the output data compressor and writer 301 finishes compressing and writes of all the output data from a previous layer, the number of zeros in the output data can be calculated and stored. While weights for each convolution layer are predetermined in accordance with output filters applied, this output data from data compressor and writer 301 and its attendant sparsity composition in turn becomes the input data of a subsequent or next layer in the convolution model processing. Table look-ups and/or programmable thresholds can be used to decide whether to use sparsity mode or not. An example is that if input data sparsity is equal or greater than 50% (meaning 50% or more input data are 0's), then typically only half of the multiplications are required to handle the remaining non-zero weights and input data. This can be true regardless of weight sparsity. In this case, speed-up of at least 2× can be achieved and hence sparsity mode is advantageous and preferred over Winograd mode, which offers a maximum of close to 2.25× speed-up or enhancement in processing time.

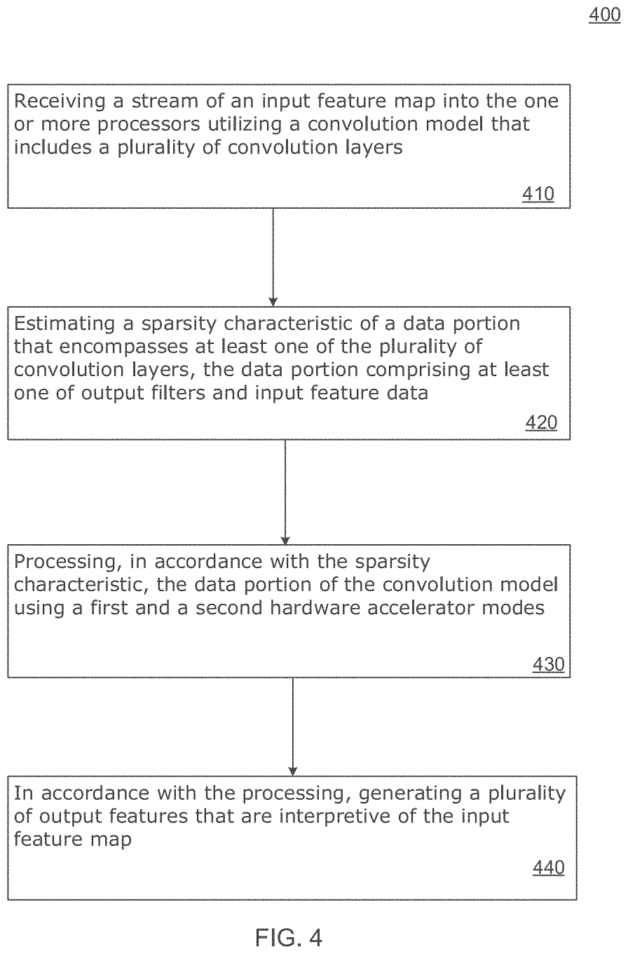

FIG. 4 illustrates, in an example embodiment, method 400 of operation for implementing a convolution model multi-mode hardware accelerator. In describing the example of FIG. 4, reference is made to the examples of FIGS. 1A, 1B, 2 and 3 for purposes of illustrating suitable components or elements for performing a step or sub-step being described.

Examples of method steps described herein relate to the use of multi-mode processing system 200 including convolution model multi-mode hardware accelerator logic module 205 for implementing the techniques described. According to one embodiment, the techniques are performed in response to the processor 201 executing one or more sequences of instructions that constitute convolution model multi-mode hardware accelerator logic module 205. In embodiments, convolution model multi-mode hardware accelerator logic module 205 may include the one or more sequences of instructions within sub-modules including feature input module 210, sparsity decision module 211, hardware accelerator multi-mode processing module 212 and output feature generation module 213. Such instructions may be read into memory 202 from machine-readable medium, including memory storage devices. In executing the sequences of instructions contained in feature input module 210, sparsity decision module 211, hardware accelerator multi-mode processing module 212 and output feature generation module 213 of convolution model multi-mode hardware accelerator logic module 205, processor 201 performs the process steps described herein.

In alternative implementations, at least some hard-wired circuitry may be used in place of, or in combination with, the software logic instructions to implement examples described herein. Thus, the examples described herein are not limited to any particular combination of hardware circuitry and software instructions. Additionally, it is also contemplated that in alternative embodiments, the techniques herein, or portions thereof, may be distributed between several processors working in conjunction.

There are a fixed number of multipliers pool in hardware accelerators to do the multiplications/convolutions of the data and weights. Normally, there are a lot of 0's (zeros) in the input feature data and/or weight (in an output filter) portion of the convolution. In the non-sparsity mode (normal mode), multipliers are used to do the multiplications of data and weights even if one or both are zero. In this case, fixed amount of time (a fixed number of hardware clock cycle) is consumed. Therefore, in both single hardware accelerator case or multiple hardware accelerators case, the number of cycles to finish a given convolution model layer is fixed.

A specific mode, the sparsity mode, utilizes the fact there can be a lot of 0's (zeros) in the input feature data and/or the weight portion of the convolution. The data and/or weight with 0's components are not used in multiplication part of the machine learning job, and this further speed up the machine learning jobs.

In this special sparsity mode case, the number of cycles to process a layer can vary, depends on the number of 0's in the input feature data and also the number of 0's constituted in the output filters.

Normally, for a layer with weights having many 0's (zero's), less multiplications are needed and hence less time to generate output data.

For example, in the filter with 3×3 weight case, there are up to total of 9 non-zero weights in each input channel. A filter of 6 zero weights (3 non-zero weights) takes less multiplications (and hence consumes less time) than a filter with no zero weights (9 valid weights).

The processing time of a given layer in sparsity mode varies due to the amount of zero weights and data in a given layer. A significant speed-up can be achieved with many zero's and much less speed-up for cases with much less zeros. In almost all cases, sparsity mode is always faster than the non-sparsity mode for direct convolution.

However, there are other than fast convolution modes such as the Winograd algorithm that can be as much as 2.25 times faster than direct convolution mode. Winograd algorithm can be faster than sparsity mode for the cases with a small number of zeros. The present invention presents a case for sparsity mode used in conjunction with other fast convolution methods, including the Winograd algorithm, for further optimization in reduction of processing time.

In an embodiment, the equations shown as direct convolution can sometime be simplified as x*w, where * denotes direct convolution. Winograd algorithm can be used in place of direct convolution. Winograd algorithm transforms both input data and weights from time domain to frequency domain. The time domain direct convolution of x*w can be represented as frequency domain pointwise multiply and can be simplified as x*w=F⁻¹ {F{x}.F{w}}, where F{x} and F{w} transform x and w from time domain to frequency domain, and “.” represents the pointwise multiplication. After pointwise multiply is performed, an inverse transform of F⁻¹ transforms the result from frequency domain to time domain.

For 4×4 input in a direct convolution mode, with 3×3 weight, 4 of 3×3 multiplications or 36 multiplications are required. For 4×4 input with Winograd, only 16 multiplications are required. This effectively is a reduction of 2.25 in processing time with Winograd.

Sparsity mode in direct convolution can be significantly faster than Winograd if data and/or weights have many 0's zeros; otherwise if data and/or weights have very little zeros, sparsity mode can be slower or taking more processing time than Winograd.

The Winograd algorithm processing time reduction over non-sparsity mode of direct convolution is fixed. The sparsity mode over non-sparsity mode processing time reduction varies. The disclosure herein presents a case for sparsity mode used in parallel and in conjunction with Winograd mode for further optimization in reduction of processing time.

The decisions on whether to use sparsity mode or Winograd mode for a given network layer can be done by the following example methods (but not limited to only these example methods):
1) Number of zeros in the weights, or output filters. Weights are known in advance so it can be calculated offline using a CPU. Table look-ups and/or programmable thresholds can be used to decide to use sparsity mode processing or not. An example is that if weight sparsity is equal or greater than 50% (5 out of 9 weights in 3×3 kernel are 0's), then typically only half of the multiplications are required to handle the remaining non-zero weights and input data. This can be true regardless of input data sparsity. In this case, speed-up of at least 2× can be achieved and hence sparsity mode is preferred over Winograd mode, which offers a maximum of close to 2.25× speed-up or enhancement in processing time.
2) Number of zeros in the input data. When the output data compressor and writer finishes compressing and writes of all the output data from a previous layer, the number of zeros in the output data can be calculated and stored. This output data in turn becomes the input data of a current layer in the convolution model processing. Table look-ups and/or programmable thresholds can be used to decide to use sparsity mode or not. An example is that if input data sparsity is equal or greater than 50% (50% or more input data are 0's), then typically only half of the multiplications are required to handle the remaining non-zero weights and input data. This can be true regardless of weight sparsity. In this case, speed-up of at least 2× can be achieved and hence sparsity mode is advantageous and preferred over Winograd mode, which offers a maximum of close to 2.25× speed-up or enhancement in processing time.

3) Input data sparsity in combination of the weight sparsity. This combines methods 1) & 2) above and use both input data sparsity and weight sparsity. Table look-ups and/or programmable thresholds can be used. This case be applicable when both weight sparsity and input data sparsity are less than 50%. Both input data sparsity and weight sparsity are examined to decide whether to use sparsity mode over Winograd mode. An example can be weight sparsity is 33% (3 out of 9 weights are 0's in 3×3 kernel mode) and input data sparsity is 25% (25% of the input data are 0's), then at least 2× speed-up can be achieved and hence sparsity mode is advantageous and preferred over Winograd mode.

An example of entire network layer is used here to switch between sparsity mode and Winograd mode, but finer granularities may be applied. For instance, a switch between sparsity mode and Winograd mode can be done on a per OC basis, still using some of the 3 methods listed above. As a result, for a given network, some layers can be running with sparsity mode and some in Winograd mode. It is also possible for a portion of the layer running with sparsity mode while another portion of the same layer is running on Winograd mode.

The proposed invention here may be applied to both single instance and multi-instance convolution models of machine learning accelerators. Though Winograd is used here as an example of fast convolution algorithms, it is contemplated that other possible fast convolution algorithms may also be applied.

In an example multi-mode hardware accelerator operation embodying at least some aspects of the foregoing convolution model example embodiments of the disclosure herein, at step 410, processor 201 executes instructions of feature input module 210 to receive a stream of an input feature map into the one or more processors utilizing a convolution model that includes a plurality of convolution layers.

In one aspect, the input feature map comprises an image, which may include a plurality of image features, such lines curving to left, to the right, upward or downward, for example.

At step 420, processor 201 of the hardware accelerator executes instructions included in sparsity decision module 211 to estimate a sparsity characteristic of a data portion that encompasses at least one of the plurality of convolution layers. The data portion includes at least one of output filters and input feature data, in an embodiment.

In an embodiment, estimating the sparsity characteristic comprises identifying a number of 0's (zeros) in the input feature data and the output filters.

In another embodiment, the method further comprises processing the data portion in the first mode when the sparsity characteristic is above a predetermined sparsity threshold.

In yet another embodiment, the method further comprises comprising processing the data portion in the second mode when the sparsity characteristic is below the predetermined sparsity threshold.

At step 430, processor 201 executes instructions included in hardware accelerator multi-mode processing module 212 to process, in accordance with the sparsity characteristic, the data portion of the convolution model using a first and a second hardware accelerator modes.

In embodiments, the method may comprise processing the data portion in the first mode when the sparsity characteristic is above a predetermined sparsity threshold, and processing the data portion in the second mode when the sparsity characteristic is below the predetermined sparsity threshold.

In one variation, the data portion encompasses any one layer within the plurality of convolution layers, when processing the data portion using the first and second hardware accelerator modes.

In another variation, the data portion encompasses a first and at least a second layers within the plurality of convolution layers, when processing the data portion of separate layers using the first and second hardware accelerator modes for respective ones of the separate layers.

In another variation, the first mode comprises a sparsity mode. In yet another variation, processing using the first and second modes may further comprise processing using at least two of (i) the first mode, (ii) the second mode, and (iii) a combination of the first mode and the second mode.

In yet another variation, the second mode comprises a fast convolution mode. The fast convolution mode may be implemented using a Winograd fast convolution algorithm that transforms the input data and output filters from a time domain to a frequency domain.

At step 440, processor 201 executes instructions included in output feature generation module 213 to, in accordance with the reconfigured computational order, generate output features that are interpretive of the input feature map.

It is contemplated that the convolution model multi-mode hardware accelerator may be implemented in one or more of a field-programmable gate array (FPGA) device, a massively parallel processor array device, a graphics processing unit (GPU) device, a central processing unit (CPU) device, and an application- specific integrated circuit (ASIC).

It is contemplated that embodiments described herein be extended and applicable to individual elements and concepts described herein, independently of other concepts, ideas or system, as well as for embodiments to include combinations of elements in conjunction with combinations of steps recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, any absence of describing combinations does not preclude the inventors from claiming rights to such combinations.

What is claimed is:

1. A method for implementing a convolution model multi-mode hardware accelerator in one or more processors, the method comprising:
receiving a stream of an input feature map into the one or more processors utilizing a convolution model that includes a plurality of convolution layers;
estimating a sparsity characteristic of a data portion that encompasses at least one of the plurality of convolution layers, the data portion comprising at least one of output filters and input feature data;
processing, in accordance with the sparsity characteristic, the data portion of the convolution model using a first and a second hardware accelerator modes; and
in accordance with the processing, generating a plurality of output features that are interpretive of the input feature map.

2. The method of claim 1 wherein estimating the sparsity characteristic comprises identifying a number of 0's (zeros) in the input feature data and the output filters.

3. The method of claim 2 further comprising processing the data portion in the first mode when the sparsity characteristic is above a predetermined sparsity threshold.

4. The method of claim 3 further comprising processing the data portion in the second mode when the sparsity characteristic is below the predetermined sparsity threshold.

5. The method of claim 1 wherein the data portion encompasses any one layer within the plurality of convolution layers, and processing the data portion using the first and second hardware accelerator modes.

6. The method of claim 1 wherein the data portion encompasses a first and at least a second layers within the plurality of convolution layers, and processing the data portion of the first and the at least a second layers using the first and second hardware accelerator modes respectively.

7. The method of claim 1 wherein the first mode comprises a sparsity mode, and processing using the first and second modes further comprises processing using at least two of (i) the first mode, (ii) the second mode, and (iii) a combination of the first mode and the second mode.

8. The method of claim 1 wherein the second mode comprises a fast convolution mode.

9. The method of claim 8 wherein the fast convolution mode is implemented using a Winograd fast convolution algorithm that transforms the input data and output filters from a time domain to a frequency domain.

10. The method of claim 1, wherein the convolution model multi-mode hardware accelerator is implemented in one or more of a field-programmable gate array (FPGA) device, a massively parallel processor array device, a graphics processing unit (GPU) device, a central processing unit (CPU) device, and an application-specific integrated circuit (ASIC).

11. A processing system comprising:
one or more processors;
a non-transient memory storing instructions executable in the one or more processors to implement a convolution model multi-mode hardware accelerator by:
receiving a stream of an input feature map into the one or more processors utilizing a convolution model that includes a plurality of convolution layers;
estimating a sparsity characteristic of a data portion that encompasses at least one of the plurality of convolution layers, the data portion comprising at least one of output filters and input feature data;
processing, in accordance with the sparsity characteristic, the data portion of the convolution model using a first and a second hardware accelerator modes; and
in accordance with the processing, generating a plurality of output features that are interpretive of the input feature map.

12. The processing system of claim 11 wherein estimating the sparsity characteristic comprises identifying a number of 0's (zeros) in the input feature data and the output filters.

13. The processing system of claim 11 further comprising processing the data portion in the first mode when the sparsity characteristic is above a predetermined sparsity threshold.

14. The processing system of claim 13 further comprising processing the data portion in the second mode when the sparsity characteristic is below the predetermined sparsity threshold.

15. The processing system of claim 11 wherein the data portion encompasses any one layer within the plurality of convolution layers, and processing the data portion using the first and second hardware accelerator modes.

16. The processing system of claim 11 wherein the data portion encompasses a first and at least a second layers within the plurality of convolution layers, and processing the data portion of the first and the at least a second layers using the first and second hardware accelerator modes respectively.

17. The processing system of claim 11 wherein the first mode comprises a sparsity mode, and processing using the first and second modes further comprises processing using at least two of (i) the first mode, (ii) the second mode, and (iii) a combination of the first mode and the second mode.

18. The processing system of claim 11 wherein the second mode comprises a fast convolution mode.

19. The processing system of claim 18 wherein the fast convolution mode is implemented using a Winograd fast convolution algorithm that transforms the input data and output filters from a time domain to a frequency domain.

20. The processing system of claim 11, wherein the convolution model multi-mode hardware accelerator is implemented in one or more of a field-programmable gate array (FPGA) device, a massively parallel processor array device, a graphics processing unit (GPU) device, a central processing unit (CPU) device, and an application- specific integrated circuit (ASIC).
